(19) United States
(12) Patent Application Publication
(10) Pub. No.: US 2004/0182648 A1
(43) Pub. Date: Sep. 23, 2004

(54) Chain drive lubrication system

(76) Inventor: Gary D. Ludwig, Carroll, IA (US)

Correspondence Address: Law Offices of Adam H. Jacobs, Suite 726, 1904 Farnam Street, Omaha, NE, 68102, US

(21) Appl. No.: 10/393,480

(22) Filed: Mar. 20, 2003

(51) Int. Cl. F16N 7/16

(52) U.S. Cl. 184/15.3

(57) ABSTRACT

A chain drive lubrication system includes a pressurized can of lubricant having a top-mounted spray nozzle and a can support structure supporting the pressurized can of lubricant generally adjacent a chain drive with the top-mounted spray nozzle aiming the chain drive. A can securement device such as a set screw is mounted on the can support holder to releasably secure the pressurized can of lubricant in the can support structure. A trigger device is mounted on the can support structure extending above the top-mounted spray nozzle, the can support structure being generally free of spray nozzle engagement structures excepting the trigger device. Finally, the trigger device is operative to alternatively depress and release the top-mounted spray nozzle thereby spraying lubricant from the pressurized can of lubricant onto the adjacent chain drive.

### BACKGROUND OF THE INVENTION

1. Technical Field

The present invention relates to lubricant application devices and, more particularly, to a chain drive lubrication system which includes a pressurized can of lubricant having a top-mounted spray nozzle, a can support structure such as a cylinder which supports and secures the pressurized can of lubricant with the spray nozzle adjacent the chain drive, a set screw or the like which releasably secures the pressurized can of lubricant in the can support structure, and a trigger device mounted on the can support structure extending above the spray nozzle, the trigger device operative to alternately depress and release the spray nozzle thereby spraying lubricant from the pressurized can of lubricant onto the chain drive.

2. Description of the Prior Art

There are many different types of farm equipment which are used today, including such implements as combines, tractors and balers. One thing that each of these implements have in common is that they all include chain drives of one type or another which are used to power their various moving elements. During use of the farm implements, each of these chain drives require lubrication in order to function correctly, which means that the operator of the farm implement must occasionally exit the cab of the unit and oil each and every one of the chain drives in order to ensure proper operation of the farm implement. While this lubrication process may ordinarily not present much of a problem, during times of extreme heat, extreme cold, or other uncomfortable weather and environment-related situations, it may not be such an easy matter to perform the necessary lubrication.

There have been numerous types of lubrication systems proposed in the prior art which attempt to solve this long-felt need. Among these are devices including those provided by companies such as John Deere and Caterpillar which involve central lubricant reservoirs connected through a series of tubes to spray nozzles adjacent the chain drives. The problem with these systems is that they are expensive (costing upwards of $2500) and furthermore that they are prone to blockage due to the length and amount of tubing required to access each of the chain drives. There is therefore a need for a lubrication system which does not require a central lubricant reservoir or a complicated set of tubing or piping to transfer the lubricant to the chain drive system to which it is to be applied.

There are numerous other types of lubrication devices which are used in connection with chain drives for motorcycles, vehicles, or other such devices including chain drives, including such devices as Mann, U.S. Pat. No. 4,120,380, Martin, U.S. Pat. No. 5,595,262, and King, Sr., et al., U.S. Pat. No. 4,977,979. Each of these devices, however, include inherent deficiencies which do not lend themselves for use with all chain drives. In particular, of the cited prior art, only Mann discloses a lubrication system which utilizes easy-to-replace pressurized cans of lubricant which are preferred for many lubrication uses. Mann, however, requires that the spray nozzle of the pressurized can of lubricant have a directional tube inserted into the spray nozzle and further that the entire can be enclosed within a can support cylinder to enable the spray nozzle to be engaged and disengaged. The design of Mann makes it exceedingly difficult to quickly remove and replace pressurized cans of lubricant from the can support device of Mann. There is therefore a need for a lubrication system for chain drives which will quickly and easily direct lubricant from a pressurized can of lubricant onto the chain drive. It will also permit quick and easy removal and replacement of empty cans of lubricant from the lubrication system.

Therefore, an object of the present invention is to provide a chain drive lubrication system which utilizes pressurized cans of lubricant.

Another object of the present invention is to provide a chain drive lubrication system which may be either manually operated or remotely operated, depending upon the desires of the user.

Another object of the present invention is to provide a chain drive lubrication system which includes a can support structure operative to support the pressurized can of lubricant generally adjacent a chain drive with the spray nozzle aiming at the chain drive for lubrication thereof.

Another object of the present invention is to provide a chain drive lubrication system in which the can support structure is generally free of spray nozzle engagement structures excepting the trigger device to permit the pressurized can of lubricant to be quickly and easily removed and replaced from the can support structure.

Another object of the present invention is to provide a chain drive lubrication system in which the pressurized can of lubricant is engaged by a trigger device mounted on the can support structure extending above the spray nozzle, the trigger device operative to alternately depress and release the spray nozzle thereby spraying lubricant from the pressurized can of lubricant onto the chain drive.

Another object of the present invention is to provide a chain drive lubrication system which does not include a central lubricant repository and a plurality of lubricant transfer tubes to transfer lubricant from the central lubricant depository to the chain drives in order to simplify the chain drive lubrication system.

Finally, an object of the present invention is to provide a chain drive lubrication system which is relatively simple to manufacture and install and is safe and efficient in use.

### SUMMARY OF THE INVENTION

The present invention provides a chain drive lubrication system which includes a pressurized can of lubricant having a top-mounted spray nozzle and a can support structure operative to support the pressurized can of lubricant generally adjacent a chain drive with the spray nozzle aiming at the chain drive. A can securement device such as a set screw is mounted on the can support structure and is operative to releasably secure the pressurized can of lubricant in the can support structure. Furthermore, the can support structure will be generally free of spray nozzle engagement structures absent the trigger device to permit the rapid insertion and removal of cans of lubricant. Finally, a trigger device mounted on the can support structure extends above the spray nozzle and is operative to alternatively depress and release the spray nozzle thereby spraying lubricant from the pressurized can of lubricant onto the chain drive adjacent the pressurized can of lubricant.

The present invention as thus described provides a substantial improvement over those devices found in the prior art. For example, the use of individual cans of pressurized lubricant make it extremely simple to replace an empty can or to repair the chain drive lubrication system should one of the cans of lubricant become inoperative. Also, because the can support structure of the present invention is generally free of spray nozzle engagement structures such as tubes or the like which are required by some devices found in the prior art to direct the lubricant onto the chain drive, the pressurized cans are quickly and easily switched when it becomes necessary to replace the cans without requiring reconnection of those spray nozzle engagement structures. Finally, because each of the trigger devices on the can support structures can be engaged separately or as a unit, chain drive specific lubrication may be performed by the present invention which many of the devices found in the prior art are not capable of. It is thus seen that the present invention provides a substantial improvement over those devices found in the prior art.

### BRIEF DESCRIPTION OF THE DRAWINGS

FIG. 1 is a perspective view of the chain drive lubrication system of the present invention;

FIG. 2 is a detail side elevational view of the present invention showing operation of the trigger device; and

FIGS. 3 and 4 are perspective views showing the present invention applying lubricant to the adjacent chain drive.

### DESCRIPTION OF THE PREFERRED EMBODIMENT

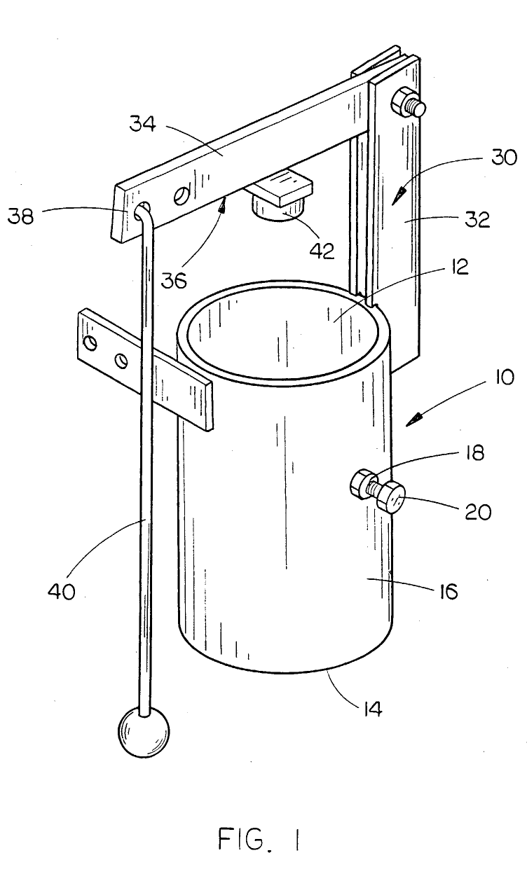

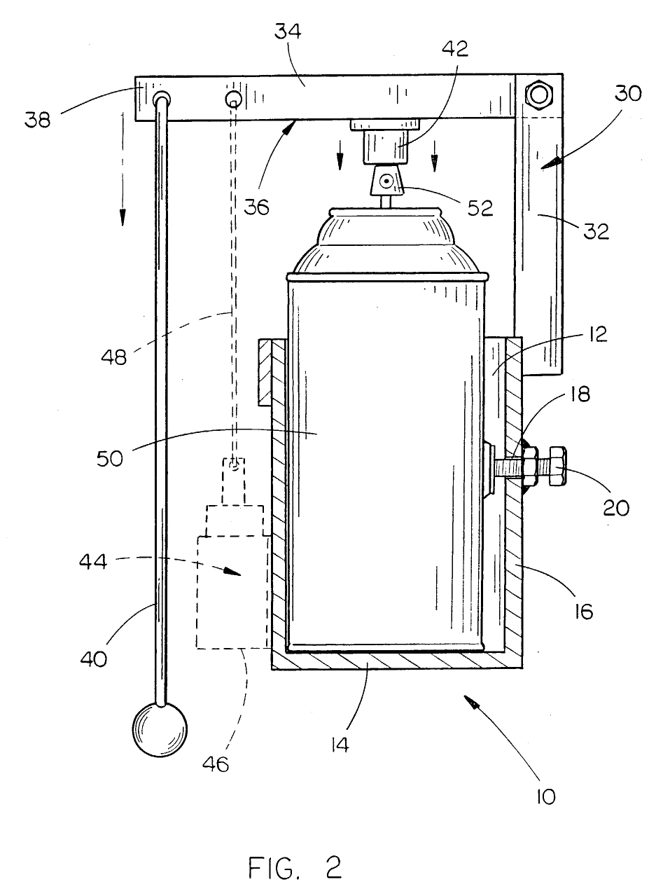

The chain drive lubrication system 10 of the present invention is shown best in FIGS. 1 and 2 as including a can support structure 12 which, in the preferred embodiment, would be a cylinder having a base wall 14 and circumferential outer wall 16. It is further preferred that the can support structure 12 be constructed of a relatively heavy-gauge sheet metal to ensure longevity of the chain drive lubrication system 10. The can support structure 12 would have a height of approximately four to eight inches and a diameter of approximately one to four inches, depending on the size of the can of lubricant which is to be supported by the can support structure 12. Extending through outer wall 16 is a threaded bolt hole 18 into which a set screw 20 is threadably inserted. The set screw 20 is designed to extend through outer wall 16 and frictionally engage the side of the pressurized can of lubricant 50 seated within the can support structure 12 as shown best in FIG. 2. The set screw 20 is designed to perform two important functions, the first being the securement of the pressurized can of lubricant 50 within the can support structure 12 and, secondly, to ensure that the pressurized can of lubricant 50 remains in an alignment which directs the spray nozzle 52 of the pressurized can of lubricant 50 towards the chain drive 80 to which the lubricant is to be applied. In the preferred embodiment, the pressurized can of lubricant 50 would be a can having a height of approximately eight to ten inches, a diameter of approximately one and a half to two and a half inches and would include a top-mounted spray nozzle 52 which can be alternately depressed and released to release lubricant from the interior of the can. The lubricant substance may be of various kinds, such as penetrating oil, silicone spray, and other commercially available products and may be contained in a non-aerosol or aerosol form. The specific lubrication qualities of the lubricant found within the pressurized can 50 will be determined by the user of the present invention and the equipment to which the lubricant is to be applied, but it is an important feature of the present invention that it can be used with commercially available pressurized lubricant cans which are easily obtainable and easily replaceable.

The trigger device 30 of the present invention is shown best in FIGS. 1 and 2 as including a generally upright strut 32 which extends generally parallel with the outer wall 16 of can support structure 12 and upwards therefrom. Pivotably connected to the top end of strut 32 is a trigger bar 34 having length of approximately three to six inches and extending generally parallel with base wall 14 of can support structure 12 over and above the can support structure 12. In the preferred embodiment, the trigger bar 34 would extend across the top of can support structure 12 above the spray nozzle 52 of the pressurized can of lubricant 50. The underside 36 of trigger bar 34 would engage the top face of spray nozzle 52 but, because of the relatively light weight of trigger bar 34, would not depress spray nozzle 52 to release lubricant from pressurized can of lubricant 50 when the trigger bar 34 is merely resting on the spray nozzle 52. Instead, release of lubricant from pressurized can 50 would be performed by exerting a downward force on the outer end 38 of trigger bar 34 which would cause underside 36 of trigger bar 34 to press downwards on spray nozzle 52, as shown best in FIG. 2. Because pressurized can 50 rests on base wall 14 of can support structure 12, the downwards force applied to trigger bar 34 causes the spray nozzle 52 to move downwards to release lubricant from the interior of pressurized can 50, thus coating the chain drive 80 with a lubricant film as intended by the user of the present invention.

In one preferred embodiment of the present invention, a manual engagement shaft 40 would depend downwards from the outer end 38 of trigger bar 34 permitting the user of the present invention to pull downwards on the manual engagement shaft 40 to force trigger bar 34 downwards engaging spray nozzle 52 to release lubricant from pressurized can 50. Alternatively, the chain drive lubrication system 10 of the present invention may be connected through a series of mechanical linkages (not shown) to a central location on the vehicle such as a vehicle cab such that force exerted at the vehicle cab on handles located within the vehicle cab would be translated through the mechanical linkages to the trigger device 30 pulling trigger bar 34 downwards to engage spray nozzle 52 to release lubricant from pressurized can 50. Finally, the use of electrically activated trigger mechanisms 44 are contemplated by the present invention and would preferably include a mechanical linkage 48 connected to the trigger bar 34 extending downwards to a solenoid device 46 which would, when engaged, provide downwards force to the trigger bar 34 causing spray nozzle 52 to move downwards to release lubricant from the interior of pressurized can 50. Of course, it should be noted that numerous other types of trigger devices and nozzle activation structures may be used with the chain drive lubrication system 10 of the present invention which accomplish the intended purpose of releasing lubricant from the pressurized can 50. For example, it may be desirable to include a rubber disk 42 or the like on the underside 36 of trigger bar 34 to engage spray nozzle 52 thus increasing the frictional contact between the spray nozzle 52 and trigger bar 34 so that the trigger bar 34 does not accidentally disengage from spray nozzle 52. These and other similar modifications would be understood by those skilled in the art.

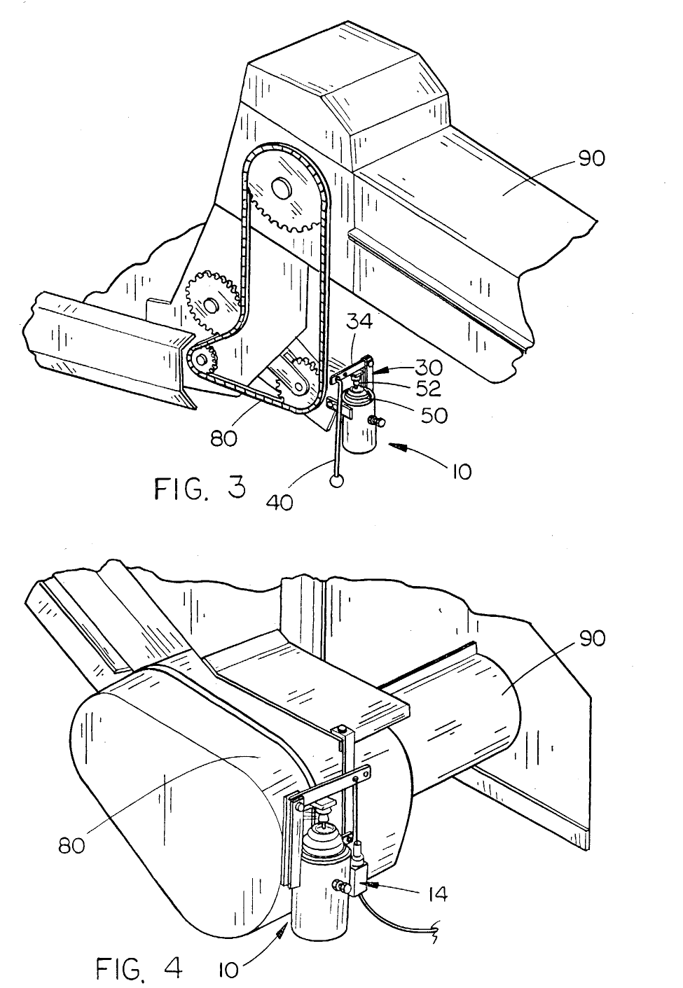

The use of the chain drive lubrication system 10 of the present invention is relatively simple compared to those devices found in the prior art. In one illustrative example as shown in FIG. 3, can support structure 12 would be secured to the body of the farm implement to which it is to be attached via a bracket or by welding, such that the can support structure 12 is adjacent the chain drive 80 to which lubricant is to be applied. Once the can support structure 12 is affixed to the body 90 of the farm implement, trigger bar 34 is swung upwards and a pressurized can of lubricant 50 is dropped into the can support structure 12. After the pressurized can of lubricant 50 is placed within the can support structure 12, the spray nozzle 52 is aligned to direct lubricant onto the adjacent chain drive 80. Set screw 20 would then be moved inwards to contact the side of pressurized can 50 and exert friction thereon to secure the pressurized can 50 within can support structure 12. The trigger bar 34 is then swung back into engagement position, as shown in FIGS. 1 and 2, any mechanical linkages are reconnected to permit operation of the trigger bar 34 and the chain drive lubrication system 10 is then ready for use. To apply lubricant to the chain drive 80, the user may either manually engage trigger structure 30 or remotely engage trigger structure 30 via mechanical linkages or electrical devices as shown in FIG. 4. Trigger bar 34 would then be pulled downwards pivoting on strut 32 until the underside 36 of trigger bar 34 exerts sufficient force on spray nozzle 52 to depress it downwards to release lubricant from the interior of pressurized can 50. Continuous downward force applied to trigger bar 34 results in continuous release of lubricant through spray nozzle 52 from pressurized can 50 until the chain drive 80 is properly lubricated and the user of the present invention is satisfied. Each of the chain drive lubrication systems 10 mounted around the body 90 of the farm implement would be engaged or disengaged in a similar manner.

It is to be understood that numerous additions, modifications, and substitutions may be made to the chain drive lubrication system 10 of the present invention that fall within the intended broad scope of the appended claims. For example, the construction materials, sizes and shapes of the various elements of the chain drive lubrication system 10 may be modified or changed so long as the intended functionality of the present invention is neither degraded nor destroyed. Also, the trigger device 30 may be modified to accommodate various sizes and shapes of pressurized cans 50 although it is preferred that the chain drive lubrication system 10 of the present invention be free of all spray nozzle engagement structures except the trigger device 30 which engages the top section of spray nozzle 52 thus ensuring that the pressurized can of lubricant 50 may be quickly and easily replaced upon being emptied. Also, the present invention, although described for use in connection with farm implements, may be used with any device utilizing a chain drive system or one which requires lubrication to perform correctly. Finally, the nature of the mechanical and electrical linkages, serving as trigger engagement devices may be modified or changed depending on the farm implement or vehicle to which the present invention is to be mounted.

There has therefore been shown and described a chain drive lubrication system 10 which accomplishes at least all of its intended objectives.

I claim:

1. A chain drive lubrication system comprising:
a pressurized can of lubricant having a top-mounted spray nozzle;
a can support structure operative to support said pressurized can of lubricant generally adjacent a chain drive with said top-mounted spray nozzle aiming at a chain drive;
a can securement means mounted on said can support holder operative to releasably secure said pressurized can of lubricant in said can support structure;
trigger means mounted on said can support structure extending above said top-mounted spray nozzle;
said can support structure generally free of spray nozzle engagement structures excepting said trigger means; and
said trigger means operative to alternatively depress and release said top-mounted spray nozzle thereby spraying lubricant from said pressurized can of lubricant onto a chain drive.

2. The chain drive lubrication system of claim 1 wherein said can support structure is generally cylindrical and includes a base wall and a circumferential outer wall.

3. The chain drive lubrication system of claim 2 wherein said securement means further comprises a set screw extending through said circumferential outer wall via a threaded bolt hole, said set screw extending through said circumferential outer wall and frictionally engaging said pressurized can of lubricant such that said pressurized can of lubricant is releasably secured within said can support structure and said spray nozzle of said pressurized can of lubricant is aimed towards the chain drive to which the lubricant is to be applied.

4. The chain drive lubrication system of claim 1 wherein said trigger means further comprises an elongated trigger bar having first and second ends and extending adjacent said spray nozzle, said first end of said trigger bar pivotably mounted on said can support structure such that directional force applied to said second end of said trigger bar forces said trigger bar into operational contact with said spray nozzle thereby engaging said spray nozzle for spraying lubricant from said pressurized can of lubricant onto a chain drive.

5. In combination:
a pressurized can of lubricant having a top-mounted spray nozzle; and
a chain drive lubrication system comprising:
a can support structure operative to support said pressurized can of lubricant generally adjacent a chain drive with said top-mounted spray nozzle aiming at a chain drive and at least a portion of said pressurized can of lubricant extending above said can support structure;
a can securement means mounted on said can support holder operative to releasably secure said pressurized can of lubricant in said can support structure;
trigger means mounted on said can support structure extending above said top-mounted spray nozzle; and
said trigger means operative to alternatively depress and release said top-mounted spray nozzle thereby spraying lubricant from said pressurized can of lubricant onto a chain drive.

6. The chain drive lubrication system of claim 5 wherein said can support structure is generally cylindrical and includes a base wall and a circumferential outer wall.

7. The chain drive lubrication system of claim 6 wherein said securement means further comprises a set screw extending through said circumferential outer wall via a threaded bolt hole, said set screw extending through said circumferential outer wall and frictionally engaging said pressurized can of lubricant such that said pressurized can of lubricant is releasably secured within said can support structure and said spray nozzle of said pressurized can of lubricant is aimed towards the chain drive to which the lubricant is to be applied.

8. The chain drive lubrication system of claim 5 wherein said trigger means further comprises an elongated trigger bar having first and second ends and extending adjacent said spray nozzle, said first end of said trigger bar pivotably mounted on said can support structure such that directional force applied to said second end of said trigger bar forces said trigger bar into operational contact with said spray nozzle thereby engaging said spray nozzle for spraying lubricant from said pressurized can of lubricant onto a chain drive.

9. A chain drive lubrication system comprising:
a pressurized can of lubricant having a lubricant release opening;
a can support structure operative to support said pressurized can of lubricant generally adjacent a chain drive with said lubricant release opening aiming at a chain drive;
a can securement means mounted on said can support holder operative to releasably secure said pressurized can of lubricant in said can support structure;
trigger means mounted on said can support structure operatively associated with said lubricant release opening of said pressurized can of lubricant;
said trigger means including an elongated trigger bar having first and second ends and extending adjacent said lubricant release opening, said first end of said trigger bar pivotably mounted on said can support structure such that directional force applied to said second end of said trigger bar forces said trigger bar into operational contact with said lubricant release opening thereby engaging said lubricant release opening for spraying lubricant from said pressurized can of lubricant onto a chain drive.

10. The chain drive lubrication system of claim 9 wherein said can support structure is generally cylindrical and includes a base wall and a circumferential outer wall.

11. The chain drive lubrication system of claim 10 wherein said securement means further comprises a set screw extending through said circumferential outer wall via a threaded bolt hole, said set screw extending through said circumferential outer wall and frictionally engaging said pressurized can of lubricant such that said pressurized can of lubricant is releasably secured within said can support structure and said lubricant release opening of said pressurized can of lubricant is aimed towards the chain drive to which the lubricant is to be applied.

12. The chain drive lubrication system of claim 9 wherein said trigger means further comprises a rubber disk mounted on the underside of said trigger bar to engage said lubricant release opening thereby increasing the amount of frictional contact between said lubricant release opening and said trigger bar whereby said trigger bar is generally prevented from accidentally disengaging from said lubricant release opening.

13. The chain drive lubrication system of claim 9 further comprising an actuating device operatively connected to said trigger means for actuating said trigger means to engage and disengage said lubricant release opening to release lubricant from said pressurized can of lubricant.

14. The chain drive lubrication system of claim 13 wherein said actuating device comprises a mechanical linkage connected to said elongated trigger bar.

15. The chain drive lubrication system of claim 13 wherein said actuating device comprises an electrical solenoid operatively connected to said elongated trigger bar.
